(19) United States
(12) Patent Application Publication
(10) Pub. No.: US 2005/0262977 A1
(43) Pub. Date: Dec. 1, 2005

(54) Machine and process for optimizing truss cutting

(76) Inventors: Steven Jerald Wilkerson, Daleville, MS (US); Daniel Norman Holland, Daleville, MS (US)

Correspondence Address: JAMES D. PETRUZZI, 4900 WOODWAY SUITE 745, HOUSTON, TX, 77056, US

(21) Appl. No.: 10/853,398

(22) Filed: May 25, 2004

(51) Int. Cl. B26D 1/00; B26D 5/00

(52) U.S. Cl. 83/13; 144/357; 83/75.5; 83/425.2

(57) ABSTRACT

A method and system for optimizing truss cutting and pre-cutting of lumber having a computer controlled sequence for cutting based on data representative of truss members, optimizing the combination of said lengths of a plurality of members to be cut from stock to minimize waste and identifying the order for cutting said stock into member lengths. The system and method iteratively compares member lengths to stock lumber lengths to optimize the cutting process and determines storage and cutting sequences.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of wood cutting and more specifically to a machine and process for optimizing truss cutting. In a preferred embodiment, the machine is used in the metal plate connected wood truss industry. These trusses are used to frame the roofs of houses, apartments, and other commercial buildings. They are made of relatively short pieces of lumber, as compared to the truss itself, and connected by metal plates with specially engineered teeth to grip the wood.

Due to the geometry of the truss, the ends of the pieces of lumber are usually cut at an angle. The primary sawing machine that cuts the angles on the lumber pieces is called a component saw. This particular saw has several blades, the angles and location of which are computer controlled and very accurate. They can cut a piece of lumber to a length within a sixteenth of an inch of accuracy and an angle to a tenth of a degree. The saw is also very fast. In a typical 8-hour time period it can typically produce around 400 unique parts with an average of 10 boards of each shape resulting in 4000 pieces.

However, the standard component saw process used in the truss industry has some deficiencies. It cuts the lumber to a specific length, but the lumber is typically available in two-foot increments. The waste, called drop, can be up to two feet long. One can reduce the amount of drop by cutting some of the lumber bundles from the mill into one foot stock lengths using a bundle cutting saw. If a finished part is to be 6 feet 6 inches long, one would cut a bundle of fourteen foot lumber in half and use seven foot stock instead of the closest commercially available stock, which is eight foot. This practice limits drop to one foot or less. However, the drop can be minimized further.

Prior art systems have attempted to use software for the optimization of cutting lumber but not in the particular innovative method shown in the present invention. For example, U.S. Pat. Nos. 6,068,034 and 5,934,347 to Phelps issued May 30, 2000 and Aug. 10, 1999 respectively show a cutting system for reducing waste due to knots in the wood but fail to show a truss cutting optimization system according to the present invention. Similarly, U.S. Pat. No. 6,196,283 to Hundegger issued Mar. 6, 2001 shows a guidance system for optimizing work piece manipulation but fails to show the inventive combination of the present invention. Likewise, U.S. Pat. No. 5,088,363 to Jones et al. issued Feb. 18, 1992 and U.S. Pat. No. 6,615,100 to Urmson issued Sep. 2, 2003 show automated and computer-controlled lumber cutting and saw assemblies but fail to disclose the inventive combination of the present invention. U.S. Pat. No. 4,017,976 to Barr et al. and U.S. Pat. No. 3,931,501 to Barr et al. show systems for optimization for yields of lumber having knots but fail to disclose the inventive combination of the present invention.

Other prior art systems and methods include U.S. Pat. No. 5,418,729 to Holmes et al., U.S. Pat. No. 5,262,956 to De Leeuw, U.S. Pat. No. 4,163,321 to Cunningham, U.S. Pat. No. 4,221,974 to Mueller et al., U.S. Pat. No. 4,839,816 to Cattrall et al, U.S. Pat. No. 4,805,679 to Czinner, U.S. Pat. No. 4,887,219 to Strauser, and U.S. Pat. No. 4,546,440 to Palmberg show various methods and apparatuses for optimizing the cutting of lumber but fail to show the inventive combination of the present invention.

Further, U.S. Pat. Nos. 4,551,810 and 4,554,635 to Levine show optimization techniques for cutting sheet material but also fail to show the inventive combination of the present invention.

None of the prior art alone or in combination shows the method and apparatus taught herein.

### BRIEF SUMMARY OF THE INVENTION

The primary advantage of the invention is to reduce the drop or waste when cutting pieces of wood for trusses.

Another advantage of the invention is to provide a computer controlled system for cutting and optimizing wood.

Another advantage of the invention is to provide an optimization method to sort wood pieces for efficient and orderly processing.

Another advantage is to provide a system for pre-cutting wood for optimal use in truss systems and for introduction of the wood to angle cutting saws.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed method for optimizing truss cutting of lumber having the steps of entering into a computer data representative of truss members including the member lengths, optimizing the combination of the lengths of a plurality of members to be cut from stock to minimize waste, identifying the order for cutting the stock into the lengths, inserting the stock for cutting by a saw; and cutting the stock into selected lengths based on the optimization.

In accordance with a preferred embodiment of the invention, there is disclosed a system for optimizing cutting of truss members having a computer for entering and storing a plurality of data representative of truss member lengths, a control sequence in the computer that selects the combination of a plurality of member lengths to be cut, the control sequence identifies the order for cutting the wood lengths by optimizing the use of stock lumber for the member lengths, a pusher controlled by the computer for engaging the stock lumber with a saw; and a saw that responds to control signals from said computer to cut said stock lumber into member lengths.

In accordance with a preferred embodiment of the invention, there is disclosed a process for optimizing truss cutting having the steps of entering into a computer data representative of at least two truss members used in trusses including their lengths, storing in the computer the data, combining the length of a first truss member with the length of a second truss member to determine a total first length, comparing the first total length to a set of pre-determined set of stock lumber lengths, increasing by one a multiple of length of the first member length and combining it with a multiple of the second member length, repeatedly increasing the multiple by one of the length of the first member length and the multiple of the second member length until an optimal combination of multiples of the first and second member lengths is obtained to minimize waste when cut from one of the pre-determined stock lumber lengths.

In accordance with a preferred embodiment of the invention, there is disclosed a method for optimizing truss cutting of lumber having the steps of entering into a computer data representative of truss members including the member lengths, optimizing the combination of the lengths of a plurality of members to be cut from stock to minimize waste, identifying the order for cutting the stock into said lengths, inserting the stock for cutting by a saw, cutting the stock into selected lengths based on the optimization, and sorting the cut stock according to pre-determined criteria for selective additional cutting.

In accordance with a preferred embodiment of the invention, there is disclosed a method for optimizing truss cutting of lumber having the steps of storing in a computer data representative of truss members including the member lengths; optimizing the combination of the lengths of a plurality of members to be cut from stock to minimize waste, identifying the order for cutting the stock into the lengths, identifying based on pre-determined criteria those lengths that fail to meet a certain pre-determined measurement, doubling the identified length, cutting the stock in said doubled amount for the identified length.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a pre-cutting saw assembly of a preferred embodiment of the invention.

FIG. 2 is a perspective view of a pre-cutting saw assembly of a preferred embodiment of the invention.

FIG. 3 is a perspective view of a component saw of a preferred embodiment of the invention.

FIGS. 4A and 4B are a flow chart of the operations that comprise the method of a preferred embodiment of the invention.

FIG. 5 is a schematic diagram of a printed length of wood used in a preferred embodiment of the invention.

FIG. 6 is a schematic diagram of a printed length of wood used in a preferred embodiment of the invention.

FIG. 7 is a computer screen shot of software control used in a preferred embodiment of the invention.

FIG. 8 is a computer screen shot of software control used in a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Prior to introducing the lumber into the final cutting machine, there is a need to optimize and facilitate the ordered cutting of pre-cut lumber. Such optimization is achieved through the interaction of a computer or other computational device and various automated saws and mechanisms for advancement of wood into the saws. The optimization process involved analyzing various criteria relating to the desired wood lengths and comparing those lengths with standard lengths of wood know as stock. For example, if it is known that one piece or member of a truss will be 4 feet long and another member 6 feet long, then the operator could cut a ten foot piece of lumber into those two pieces and when they are run through a component saw there would be no waste or “drop.” The system of the current invention finds the length of all the pieces in a truss or set of trusses and then determines the optimum way of cutting them so that there is a minimum of drop. The current system further facilitates the handling and movement of pre-cut lumber prior to introduction to the component saw. In most sets of trusses, using the system of the present invention will reduce the waste significantly.

Before describing in detail the computer control and optimization aspects of the present invention, an overview of the truss pre-cutting and cutting process is herein provided. The characteristics of a particular truss are entered into a computer or other processing and storage device and the optimizer software analyzes the data and produces an ordered list of the pieces to cut. In a preferred embodiment system the data entry is “automatic,” i.e. the data is obtained directly from another software program that includes information about various truss designs. The information entered may include the member name, the truss or trusses a member is used within, and the length of the member. The pre-cutter computer analyzes this list of members, finds the member combinations which will produce the least drop, and orders the list of combinations to maximize subsequent operation efficiency.

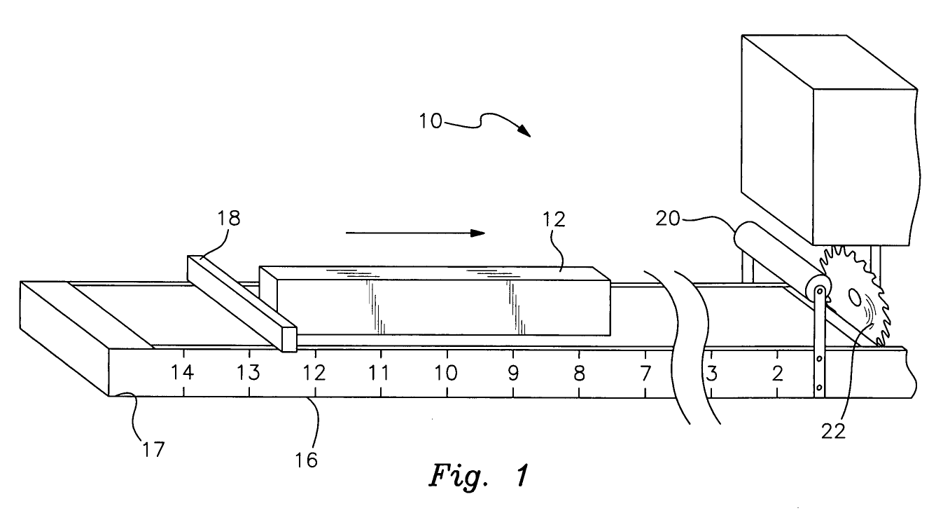

In a preferred embodiment, the pre-cutter can receive from one to six pieces at a time, although this may be varied depending on the pre-cutting equipment and may be altered to fit the situation. The usefulness of processing multiple stock pieces at the same time is the increase of volume processed, avoiding any additional machine movements. Turning now to FIG. 1, there is shown a perspective view of pre-cutter assembly 10 in accordance with a preferred embodiment of the invention. Pre-cutter assembly 10 interacts with computer hardware and software to optimize the wood cutting process. An operator takes board 12 and places it on advancer 14 for initial cutting and marking using the system of the present invention. Board 12 is typically taken from stock lengths of board. In the preferred embodiment lengths of 8, 10, 12 and 14 feet are used because they are the most economical stock lengths of the grade and species required. Board 12 may be placed alongside several boards of the same length for pre-cutting, although only one board is shown for ease of explanation. Depending on the configuration of advancer 14 and the size of pre-cutter assembly 10, numerous boards may be mounted for cutting. In a preferred embodiment, up to six stock lumber pieces may be placed on advancer 14 for pre-cutting. Advancer 14 has a solid base upon which the boards are mounted and advanced toward the saw. In an alternative embodiment, advancer 14 may have a series of transverse rollers that support the stock boards and facilitate their movement into position for cutting by saw 22.

Board 12 is placed on advancer 14 and is moved by pusher 18 the appropriate length to be cut by saw 22. Pusher 18 is mechanically driven and computer controlled and through operation of a system more fully described below, is advanced the proper length for cutting the stock lumber into calculated lengths to minimize the waste and optimize the use of the lumber needed for the trusses that will be constructed later. Once pusher 18 has advanced board 12 the proper length as previously determined by the optimization software, saw 22 fires automatically and cuts the piece to the desired length. This is repeated for each part combination in the cut list.

This pre-cutting step is important because it, in conjunction with the optimizer software, determines what stock boards to cut and what lengths result. By analyzing the different lengths needed to build various trusses, the wood can be cut in exactly the lengths needed and done in the most optimal fashion thus reducing the drop.

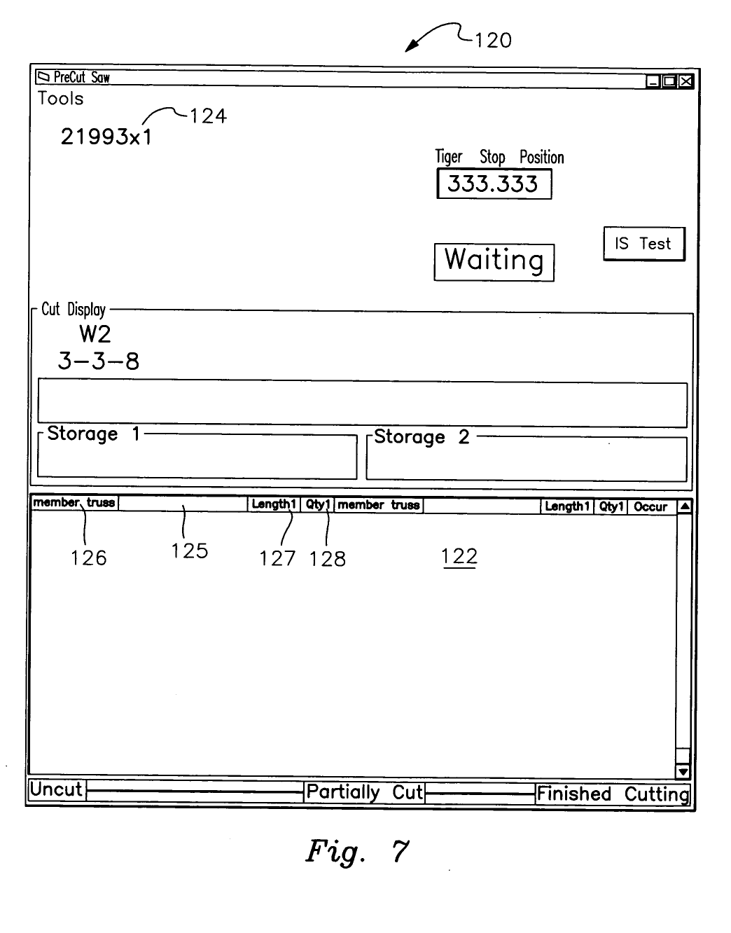

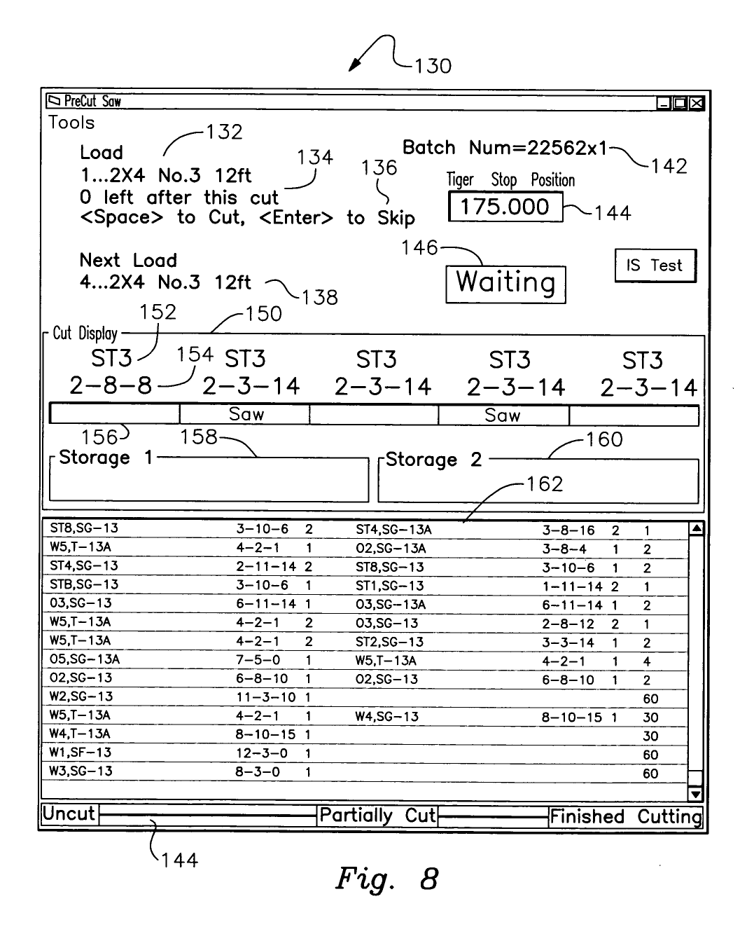

Advancer 14 is marked in one foot increments 16 to help the operator to verify the proper length of lumber as directed by the computer as described. By having easy to see increments, the operator readily knows the proper length of board as directed to place on the advancer and knows where the pusher is positioned relative to the length of board to be cut. As more fully shown in FIGS. 7 and 8, the operator is presented with real time information about the stock pieces to choose for a particular member or members that are being cut and the location of pusher 18 as it advances the wood to saw 22.

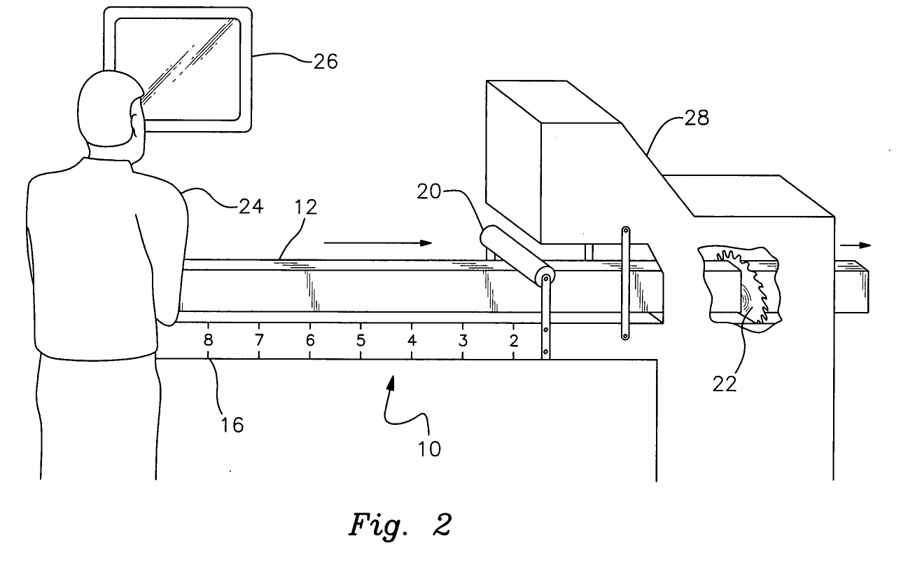

FIG. 2 shows operator 24 using computer 26 to determine what lengths of stock wood to place on the pre-cutter and then when to operate the pusher to move the board into position to be cut with saw 22. The software control that governs pusher 18, printing and pre-cutting is described more fully below. Once the stock is loaded and the operator indicates to the computer that all is ready, the pusher moves the board along the advancer table into the sawing area for engagement with saw 22. The saw cuts the stock and the stock is advanced to the next cutting position until the part combination is completed. The pusher then returns to the proper starting position to receive the next set of stock boards. Top roller 20 maintains the board in a proper position to facilitate printing information on the boards and protecting the print heads as more fully described below.

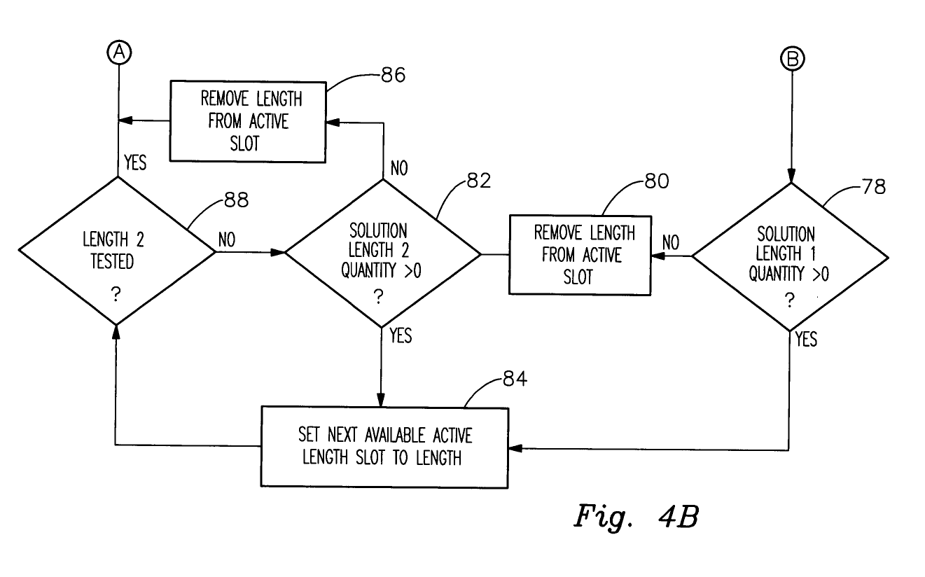

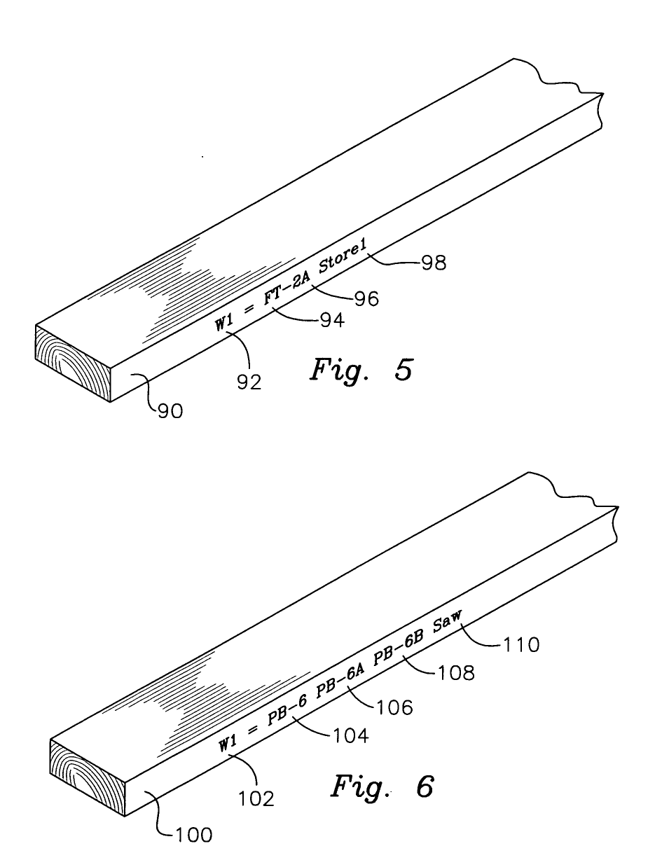

Housing 28 provides for printing of the boards with specific information later used by the operator to determine proper final cutting or storing of the pre-cut boards. The printing operation occurs simultaneously as the stock is advanced. The operator removes the resulting parts and delivers them to the proper location for subsequent processing according to the marks printed on the part. Aspects of this printing step will be further described in FIGS. 5 and 6. Housing 28 may also contain any number of devices for applying information on the boards including stickers, bar codes, grading information or whatever information the user wishes to place on the board for later use.

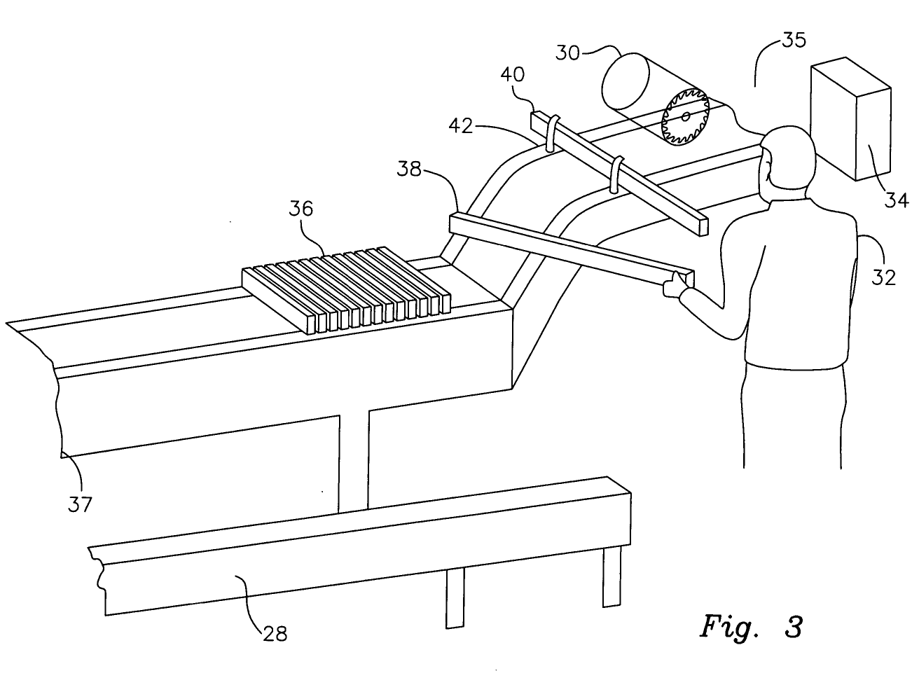

Turning now to FIG. 3, there is shown operator 32 taking pre-cut lumber and making the final angle cuts on the boards for later construction into trusses. Once the boards have been optimally cut into their proper lengths by a pre-cutter, a second operator 32 takes those boards and engages them with component saw 35. Component saw 35 is shown here with one angle saw 30, but is capable of having numerous angle saws for cutting different ends of a board, at different locations and at different angles and in a preferred embodiment has five saws. As will be readily appreciated, the pre-cutting saw and component saw may be housed in one machine with sorting and sawing steps automated as well. Here, the component saw is shown as a separate saw where the pre-cut wood is manually loaded, however, in a system in accordance with the present invention, the pre-cutter may have the ability to store certain pre-cut boards for later introduction into the component saw and the ability to deliver certain other pre-cut boards directly into the component saw.

Angle saw 30 of component saw 35 is designed to rotate into different positions to apply different angle cuts on the ends of lumber. Wood that has been designated for sawing is placed on rack 37. Rack 28 is used to store pre-cut lumber for later angle cutting.

Operator 32 uses computer 34 to determine which boards to cut, the angles needed and the other setup requirements before engaging the component saw. As later described, the pre-cut boards ar marked for immediate cutting, or storing on rack 28. Obviously, numerous modifications may be made to the racks, numbers of angle saws and the like without departing from the scope and spirit of the invention.

To further understand the benefits of pre-cutting and optimization, an example of cutting a four foot and six foot piece from a ten-foot stock length is instructive. For example, for a particular truss or trusses, 18 lengths of six foot boards are needed. In one embodiment, the pre-cutter saw can only cut from six stock pieces of lumber at a time. If a ten foot stock piece is used, one can produce 6 pieces of the four foot and 6 pieces of the six foot lengths with each cycle of the saw. Since it is desirable to reduce the set up time of the component saw to avoid alternate setups between the four and six foot pieces, it is desirable to set aside or store one of these lengths while running the other through the component saw.

The pre-cutter system and software keeps up with where each piece in the process should go. If the piece has ‘Saw’ printed on it, the operator should place it directly in the queue to be cut by the component saw. FIGS. 5 and 6 show examples of such printing on the boards. If it has Store1 printed, it should be placed in the first Storage area; Store2 should be placed in the second storage area. Since one can typically cut two different lengths from each stock length, there must be at least two different storage areas. In other embodiments, it may be possible to optimize for three different lengths from one piece of stock lumber and in that situation three storage areas may be desired.

The pre-cutter also directs the operator when to place the pieces in the Storage areas into the queue for the component saw. A flashing message is displayed on the screen indicating which storage area should be emptied into the component saw queue.

It is desirable to minimize the number of times the component saw is set up for a unique piece. Optimally, the component saw should be set up once for each type of member and used to cut all of those pieces with identical specifications at the same time. This presents an issue for the pre-cutter process, because almost every cycle will be producing two different types of pieces. The solution is to store one of those types until the total number of pieces needed is produced, then put it in the queue to the component saw.

An algorithm employed by the software control to perform this task is generally described as follows:

1. Gather and store member information from a truss data file and place it in a raw member data table. Include all the member's pertinent data such as quantity, length, end angles, name, and the truss to which it belongs.

2. Sort the table according to member name, angles, lumber grade/size, and length.

3. Create a ‘unique member’ table from the raw member table containing distinct types of these members. The trusses may contain more than one member with the same length and angles. Combine these to create one row of the unique member table, containing the total quantity and keeping up with the name of each member.

4. Remove members that can be cut out of scrap

5. Add 1/4 inch to the length to allow for the lumber stop on the saw The saw has a margin of error that is accommodated by adding a 1/4 inch of length to the member.

6. Decide if there is a need to double the length of any member so that the component saw can cut it due to the small length of the member. As previously described the component saw has large circular saw blades on each side and as these are rotated further inward to cut the member at the proper angle, it increases the minimum length board that can be cut without the blades colliding. It must be checked to see if the length, because of the angles, will be too small to go through the saw. If so, the precut piece is doubled in length and halved in quantity. It is also required to change the file that controls the setup of the saw so that a minimum of cuts are required to produce the two final members.

7. Optimize the members by using a solution table. From the ‘unique member’ table containing unique members that can be cut by the saw, a ‘solution’ table is created. This solution table contains all the possible combinations which can be cut out of stock lengths. In the preferred embodiment each combination consists of two unique members. In the preferred embodiment, the stock lengths that are preferably used in the solutions are 8, 10, 12 and 14 foot lengths. However, the system may be set to calculate using any of a set of lengths appropriate to the situation. In order to reduce the amount of pieces that have to be sorted after being cut by the pre-cutter, only two different lengths are allowed in any one solution in a preferred embodiment. An example of a solution table solving for two lengths of parts that are needed is shown in Table 1 below.

TABLE 1

| Length 1 | Qty 1 | Length 2 | Qty 2 | Drop Length | Stock Length |
|---|---|---|---|---|---|
| 2.25 | 4 | 2.2083 | 1 | 2.79163 | 14 |
| 2.25 | 4 | 2.2083 | 2 | .58333 | 14 |

To create the solution table, the first unique member is started at a quantity of one and a second unique member at a quantity of zero. The stock length that results in the least drop length from that combination is found and enter all of the data in the solution table.

One is then added to the quantity of the second unique member and the process is repeated until the combined lengths are too long to fit in any standard stock length. One is added to the quantity of the first unique piece and the process is started over. After all of the members have taken their place in the first unique member slot, a solution table with every possible combination of members is obtained.

8. The ‘solution’ table on the drop length is sorted in an ascending order.

9. A cutting list from the solution table is produced for the operator.

It must be decided in which order to cut the members on the pre-cutter. This involves balancing two factors. First, the saw should never be set up twice for any unique member, and two, the drop should always be minimized. The solution to this is to search for the best way to finish only two unique members at a time. Before advancing on to a third type of member, one must first make sure that all of one of the other type's quantity is cut first. After completing this process, a ‘cut’ table is derived that details the flow of materials through the pre-cutter.

Finally, it is determined if the member should go into the saw queue, storage area 1 or 2, or when members should come out of the storage areas and into the saw. This creates a final cut list that is converted to a database table and read by the pre-cutter.

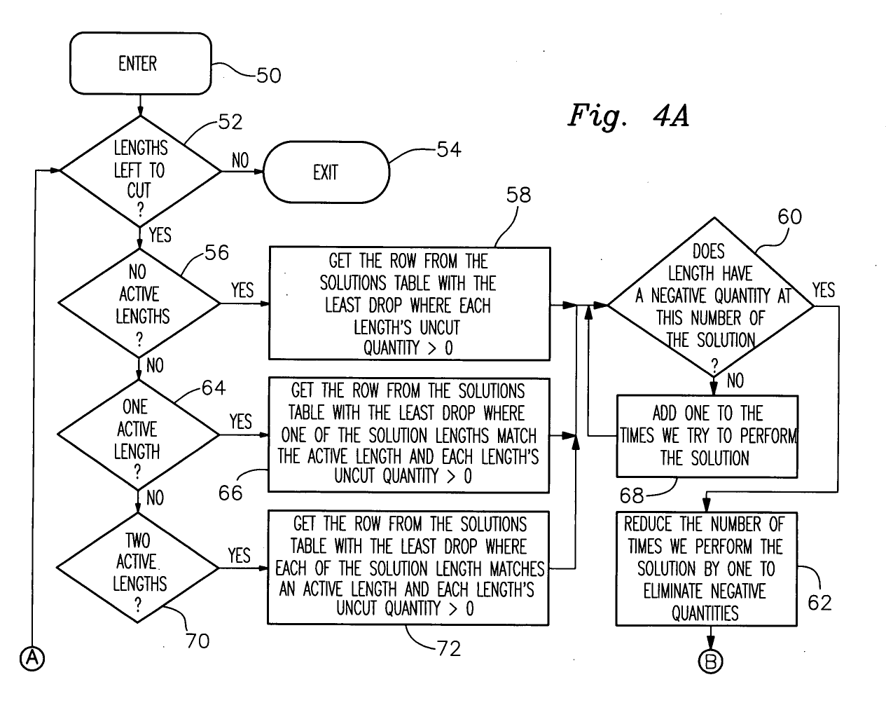

Turning now to FIGS. 4A and 4B, there is shown a flow chart showing the steps of the optimizer system used in the inventive system embodied herein. Generally, the optimization for pre-cutting is achieved by a series of iterative steps controlled by the software to generate a preferred scheme of cutting for the pre-cutter. The software optimization process starts at enter box 50 and utilizes the solution table created by the data corresponding to the different truss members in a truss of group of trusses. Query box 52 begins the process and seeks whether there are any lengths of lumber left to be cut. If the answer is no, the program is exited at box 54. If the answer is yes, box 56 seeks to determine if there are no active lengths to test. If the answer is yes, box 58 gets the row from the solutions table with the least drop where each length's uncut quantity is greater than zero. The next step is at box 60 where it is determined whether a length has a negative quantity at this number of the solution. If yes, then the process proceeds to box 62 where it reduces the number of times to perform the solution to eliminate negative quantities. From box 62, the process proceeds to box 78 to determine if the solution for length 1 has a quantity greater than zero.

If the solution for length 1 has a quantity greater than zero, then the process goes to step 84 and sets the next available active length slot to length. If not, it removes the length from the active slot at box 80 and proceeds to query box 82. In query box 82, the process determines if for solution length 2, the quantity is greater than zero. If so, it proceeds to step 84. After step 84, the process queries at box 88 whether length 2 has been tested. If not, the process goes back to step 82. If at step 82, the solution length 2 quantity is zero, then it proceeds to step 86 where the active length is removed from the active slot. The process then begins again at step 52. by proceeding along this iterative process, a combination of 2 board lengths in multiples of each length is arrived at that possesses the minimum drop. The computer is thus capable of determining the optimal pre-cut combination of different members from a truss to efficiently cut the proper number of boards from the various stock lengths.

FIG. 5 shows board 90 that has been pre-cut and printed upon. Just prior to cutting the lumber, certain information is printed on individual pieces. Each piece in the truss has a name, and that is the first thing printed. For example, as shown in FIG. 5 a piece may be called W1. This helps in keeping track of the pieces as they move through the system. The second is the name of the truss they go in. It is possible that one piece can fit into several similar trusses, so the name of all the trusses in which this piece could fit is printed. Last, the piece is printed with information indicating whether the piece should go immediately to the component saw, or set aside and stored until all of that piece type has been cut. Select for each particular piece whether it is to be stored or sent to the component saw for cutting. Truss designator 92 “W1” is the designation for a specific member of a truss configuration having a length and angle that describes that particular member. Truss designator 94 and 96 are the particular trusses that piece “W1” will fit into. Location designator 98 will indicate whether the piece is for storage or immediate sawing. Thus member “W1” may go into truss FT-2A and for this sequence of cutting should be stored in storage location 1 until all pieces marked “saw” are cut.

FIG. 6 shows a board that likewise has been printed with truss member information and truss type but is designated for “saw” meaning that it should be moved into position for the component saw and cut by the component saw prior to retrieving lumber from the “store 1” or “store 2” locations on the racks. Member designator 102 shows it is a part named W1, that goes into three trusses designated as truss 104 “PB-6,” truss 106 “PB-6A,” and truss 108 “PB-6B.” This piece has been designated for the saw and is marked with location identifier “saw.”

FIG. 7 is load screen 120 from the computer program used by the pre-cutter operator in determining what sizes of lumber to load on the pre-cutter assembly. Screen position 122 shows the software application ready for the operator to choose a batch of trusses to cut. Batch number 124 is shown in to the operator who can choose by hitting the enter key on the keyboard. For a particular cut, table 125 shows member and truss designation 126, “length 1” designation 127, “quantity 1” 128, and similar information for the other truss member being cut in that sequence. Once a choice is made, the operator presses the space key on the keyboard to load a batch for cutting. Obviously any number of additional input devices may be used including a mouse, wireless controller, joystick or other common and well known devices to operate the computer.

FIG. 8 is pre-cutter interface screen 130 of a preferred embodiment of the computer program used by the pre-cutter operator software system used in the invention. Lumber quantity 132 tells the operator the type and quantity of lumber to load. In this example, it tells the operator to load 1 piece of 2×4 No. 3 lumber that is 12 feet long. Below that is shown “lumber left” 134 which is the quantity to load after the current cycle is complete. In this example, there is no wood left after this cut. Action bar 136 tells the operator that hitting the space key on the keyboard will start the cycle and hitting the enter key will skip the current cycle. Next load 138 shows the operator the next type and quantity to be retrieved while the current cycle is underway. In this example, the computer tells the operator to get 4 pieces of 2×4 No. 3 lumber that is 12 feet long.

Current batch 140 is shown in the upper right shows the batch number that is being cut. Designator 142 “×1” indicates that the batch is being cut one time for one building or truss application. In other situations, designator 142 may indicate “×2” or “×3” and so forth to show that the batch needs to be performed numerous times since the particular truss is used several times in the building for which the trusses are being constructed.

Pusher bar indicator 144 shows the position of the pusher bar as a means to indicate to the operator that the machine is in operation and lumber is being moved into the saw. The indicator shows inches of distance from the saw. In this example, the pusher is positioned at 175 inches from the saw. Waiting indicator 146 tells the operator that the machine is currently idle. This indicator changes to “working” when the lumber is being advanced and cut.

Cut display box 150 indicates how the stock length lumber will be cut. It displays the member name 152, length 154, and destination 156 for each pre-cut piece. Length 154 is measured in a three number sequence for feet, inches and sixteenths of an inch. Thus in length 154, the member length designation of “2-8-8” means a piece of lumber that is 2 feet, 8 inches and 8 sixteenths of an inch long. Storage 1 box 158 and Storage 2 box 160 will display the word “saw” when it is time for the operator to move lumber from their respective storage areas to the advancer and ultimately into the saw.

Grid 162 displays all the cuts for a batch and may change colors according to the legend where it states “uncut, partially cut and finished cutting” at the bottom of the screen to indicate the status of a particular cut. The operator can decide which cut to perform by using the arrow keys on the keyboard or other input devices to scroll up and down the grid.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method for optimizing truss cutting of lumber comprising:
entering into a computer data representative of truss members including said member lengths;
optimizing the combination of said lengths of a plurality of members to be cut from stock to minimize waste;
identifying the order for cutting said stock into said lengths;
inserting said stock for cutting by a saw; and
cutting said stock into selected lengths based on said optimization.

2. A method for optimizing truss cutting of lumber as claimed in claim further comprising the step of marking said stock with data representative of said members.

3. A method for optimizing truss cutting of lumber as claimed in claim 1 further comprising the step of automatically advancing said stock for cutting by said saw.

4. A method for optimizing truss cutting of lumber as claimed in claim 1 further comprising the step of identifying said cut stock according to pre-determined criteria for a subsequent cutting process.

5. A method for optimizing truss cutting of lumber as claimed in claim 1 further comprising the step of advancing said cut stock into a second saw for cutting of angle cuts on at least one end of said cut stock.

6. A system for optimizing cutting of truss members comprising:
a computer for entering and storing a plurality of data representative of truss member lengths;
a control sequence in said computer that selects the combination of a plurality of member lengths to be cut;
said control sequence identifies the order for cutting the member lengths by optimizing the use of stock lumber for said member lengths;
a pusher controlled by said computer for engaging said stock lumber with a saw; and
a saw that responds to control signals from said computer to cut said stock lumber into member lengths.

7. A system for optimizing cutting of truss members as claimed in claim 6 further comprising print heads for printing information on said cut stock.

8. A system for optimizing cutting of truss members as claimed in claim 7 wherein said information comprises at least one truss member identifier.

9. A system for optimizing cutting of truss members as claimed in claim 7 wherein said information comprises a storage location for said cut stock.

10. A system for optimizing cutting of truss members as claimed in claim 6 wherein said control sequence analyzes a combination of at least two member lengths in determining the optimal cutting order.

11. A process for optimizing truss cutting comprising the steps of:
entering into a computer data representative of at least two truss members including their length;
storing said data in said computer;
combining said length of a first truss member with said length of a second truss member to determine a first total length;
comparing said first total length to a set of pre-determined set of stock lumber lengths to obtain a drop length;
increasing by one a multiple of length of said first member length and combining it with a multiple of said second member length and comparing said total second length to a set of pre-determined set of stock lumber lengths to obtain a drop length;
repeatedly increasing the multiple by one of said length of said first member length and said multiple of said second member length until an optimal combination of multiples of said first and second member lengths is obtained to minimize drop length when cut from one of said pre-determined stock lumber lengths.

12. A process for optimizing truss cutting as claimed in claim 11 wherein said data is transferred to said computer from a database.

13. A process for optimizing truss cutting as claimed in claim 11 wherein said first total length is added to a third member length and compared to said set of stock lumber lengths to calculate a minimum drop length.

14. A method for optimizing truss cutting of lumber comprising:
entering into a computer data representative of truss members including said member lengths;
optimizing the combination of said lengths of a plurality of members to be cut from stock to minimize waste;
identifying the order for cutting said stock into said lengths;
pushing said stock on an advancer for cutting by a saw;
cutting said stock into selected lengths based on said optimization; and
sorting said cut stock according to pre-determined criteria for selective additional cutting.

15. A method for optimizing truss cutting of lumber as claimed in claim 14 wherein said stock is measured against pre-marked increments on said advancer.

16. A method for optimizing truss cutting of lumber as claimed in claim 14 wherein said cut stock is sorted for storage in at least one storage location.

17. A method for optimizing truss cutting of lumber as claimed in claim 14 wherein said entry is from a pre-stored database.

18. A method for optimizing truss cutting of lumber comprising:
storing in a computer data representative of truss members including said member lengths;
optimizing the combination of said lengths of a plurality of members to be cut from stock to minimize waste;
identifying the order for cutting said stock into said lengths;
identifying based on pre-determined criteria those lengths that fail to meet a certain pre-determined measurement;
doubling said identified length;
cutting said stock in said doubled amount for said identified length.

19. A method for optimizing truss cutting and pre-cutting of lumber as claimed in claim 18 further comprising cutting said doubled length on each end with an angle cutting saw.

20. A method for optimizing truss cutting and pre-cutting of lumber as claimed in claim 18 wherein said stored data is obtained from a separate computer program.
